(19) United States
(12) Patent Application Publication
(10) Pub. No.: US 2016/0353176 A1
(43) Pub. Date: Dec. 1, 2016

(54) CONTEXTUAL CONTENT PROGRAMMING

(71) Applicant: Cisco Technology, Inc., San Jose, CA (US)

(72) Inventors: Tony LEIGH, Wokingham (GB); Simon John Parnall, Kingswood (GB); Pete Rai, Egham (GB); Stephen Tallamy, Sandhurst (GB)

(21) Appl. No.: 15/043,565

(22) Filed: Feb. 14, 2016

(30) Foreign Application Priority Data
May 28, 2015 (GB) 1509187.9

(51) Int. Cl. H04N 21/482; H04N 21/262; H04N 21/858; G06F 17/27; H04N 21/61; H04N 21/488; H04N 21/4147; H04N 21/84; H04N 21/41

(52) U.S. Cl. CPC H04N 21/482; H04N 21/84; H04N 21/262; H04N 21/8586; H04N 21/4126; H04N 21/6125; H04N 21/4882; H04N 21/4147; G06F 17/2775

(57) ABSTRACT

In one embodiment, a method implemented on a computing device includes: analyzing textual source content from a currently presented webpage on the computing device, based on the analyzing, determining at least one content theme contextually related to the webpage, receiving details of at least one currently scheduled television program on the computing device, where the at least one currently scheduled television program is matched to the at least one content theme, and rendering the currently presented webpage to include at least an indication of the currently scheduled television program in accordance with the details.

### FIELD OF THE INVENTION

The present invention generally relates to the provision of content programming based on a current browsing context.

### CROSS REFERENCE

The present application claims the benefit of priority from UK Patent Application GB 1509187.9, entitled CONTEXTUAL CONTENT PROGRAMMING, and filed May 28, 2015.

### BACKGROUND OF THE INVENTION

A typical video service provider may provide a viewer with hundreds of channels of content programming. While such a large selection of programming options may nominally make it easier for a viewer to find and take advantage of content programming that interests him/her, in practice, the sheer number of possible options may actually make it more difficult for a viewer to select programming of interest.

### BRIEF DESCRIPTION OF THE DRAWINGS

The present invention will be understood and appreciated more fully from the following detailed description, taken in conjunction with the drawings in which:

FIG. 1 is a simplified pictorial illustration of an exemplary webpage, constructed and operative in accordance with embodiments of the present disclosure;

FIG. 2 is a schematic illustration of an exemplary computing device on which the webpage of FIG. 1 is presented;

FIG. 3 is a flowchart of a process run on the device of FIG. 2 to produce the webpage of FIG. 1; and

FIG. 4 is a simplified pictorial illustration of a multi-device implementation of the process of FIG. 3, constructed and operative in accordance with embodiments described herein.

### DESCRIPTION OF EXAMPLE EMBODIMENTS

### Overview

A method implemented on a computing device includes: analyzing textual source content from a currently presented webpage on the computing device, based on the analyzing, determining at least one content theme contextually related to the webpage, receiving details of at least one currently scheduled television program on the computing device, where the at least one currently scheduled television program is matched to the at least one content theme, and rendering the currently presented webpage to include at least an indication of the currently scheduled television program in accordance with the details.

### DETAILED DESCRIPTION OF EXAMPLE EMBODIMENTS

It will be appreciated that an individual's preferences and interests do not normally exist in a vacuum. If a subject is of interest to a person in the context of one activity, it is likely that the same subject will be of interest to the person in the context of other activities. For example, a person that is reading a book about Shakespeare may be inclined to view a presentation of one of Shakespeare's plays. Similarly, a computer user that is browsing a given website may be inclined to view television programming that is contextually similar to the subject of the material on the website being browsed.

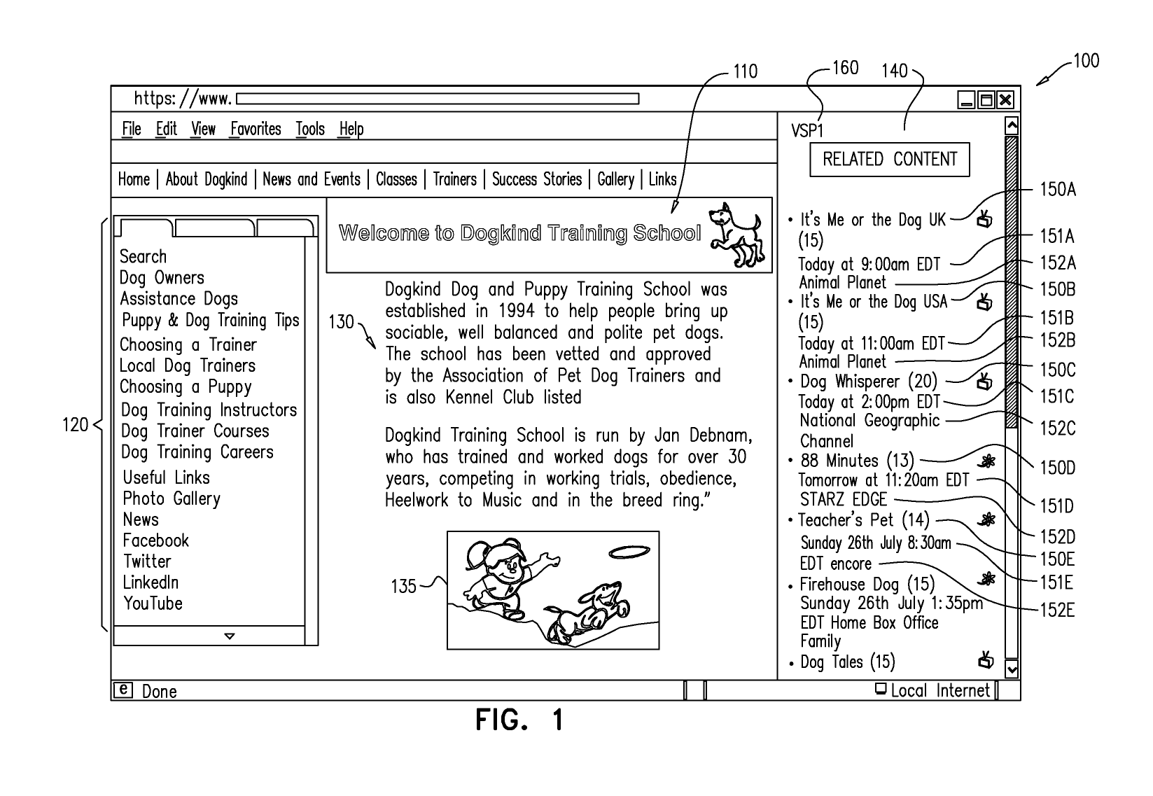

Reference is now made to FIG. 1 which illustrates an exemplary webpage 100, constructed and operative in accordance with embodiments described herein. Webpage 100 comprises title banner 110, page tabs 120 and prose 130. As may be understood from title 110, “Welcome to Dogkind Training School,” webpage 100 is associated with a school for training dogs. Each of page tabs 120 may be associated with a clickable tab for navigating to a different page on the same website as webpage 100; and prose 130 is descriptive content associated with the topic of webpage 100. It will be appreciated by one of ordinary skill in the art that prose 130 may be exclusively, or at least primarily, comprised of text characters.

Webpage 100 also comprises temporal context section 140 which in turn comprises a multiplicity of temporal context choices 150. Temporal context choices 150 represent available content choices that are associated with a common factor such as a keyword or theme derived from the contents of webpage 100. For example, per the exemplary embodiment of FIG. 1, each of temporal context choices 150 is associated with a currently scheduled television program that is contextually related to the content of webpage 100. Temporal context choice 150A is associated with a television program entitled: “It's Me or the Dog (UK)” that may be contextually related to one or more textual items in title banner 110, page tabs 120, and/or prose 130.

Furthermore, as shown in FIG. 1, each temporal context choice 150 is associated with a scheduled broadcast time 151 and a broadcast channel 152. For example, temporal 150A is associated with scheduled broadcast time 151A (“Today at 9:00 AM”) on broadcast channel 152A (“Animal Planet”). Similarly, temporal context choice 150B (“It's me or the Dog (US)”) is associated with scheduled broadcast time 151B (“Today at 11:00 AM”) on broadcast channel 152B (“Animal Planet”). It will be appreciated that temporal context choice 150C, scheduled broadcast time 151C and broadcast channel 152C are similarly associated; as are each of temporal context choices 150D and 150E with scheduled broadcast times 151D and 151E, and broadcast channels 152D and 152E, respectively.

It will be appreciated that temporal context choices 150 may be associated with a specific service provider. Webpage 100 may therefore also comprise a service provider indicator 160 to identify the service provider through which temporal context choices 150 are available. In the exemplary embodiment of FIG. 1, temporal context section 140 may be configured to present content available from a television broadcaster. Temporal context choices 150 therefore represent television programs scheduled for broadcast by the television broadcaster at scheduled broadcast times 151 on broadcast channels 152. It will, however, be appreciated by those of skill in the art that depending on the source of the temporal context choices 150, other configurations of temporal context section 140 may be supported by embodiments disclosed herein. For example, webpage 100 may be configured to present temporal context choices 150 that are available from video-on-demand (VOD), catchup services, DVR recordings (either local or cloud-based) and/or over-the-top (OTT) services such as, for example, Netflix. For such sources, other configurations of temporal context section 140 may be presented in webpage 100. For example, catalogue information and/or original broadcast times may be presented instead of, or in addition to, scheduled broadcast times 151 and/or broadcast channels 152.

In operation, temporal context choices 150 and associated scheduled broadcast times 151 and broadcast channels 152 are autonomously provided in temporal context section 140 based on a contextual relationship with the contents of webpage 100. Depending on the configuration of webpage 100, temporal context choices 150 may be linked via the service provider indicated by service provider indicator 160 to present the referenced temporal context choice 150 on a current device, i.e., the device on which webpage 100 is presented. For example, a user may click on temporal context choice 150A to switch to the “Animal Plant” channel (per broadcast channel 152A) in order to view the program “It's Me or the Dog (UK)” on the current device. Alternatively, or in addition, webpage 100 may be configured to start recording from the “Animal Plant” channel at 9:00 AM EDT (per scheduled broadcast time 151A). Alternatively, or in addition, webpage 100 may be configured to present or record the program referenced by temporal context choice 150 on a second device, such as for example, a television, a set-top box (STB) and/or a DVR. Alternatively, or in addition, webpage 100 may be configured to open a different website and/or to launch another application such as, for example, an OTT application through which the underlying content may be accessed.

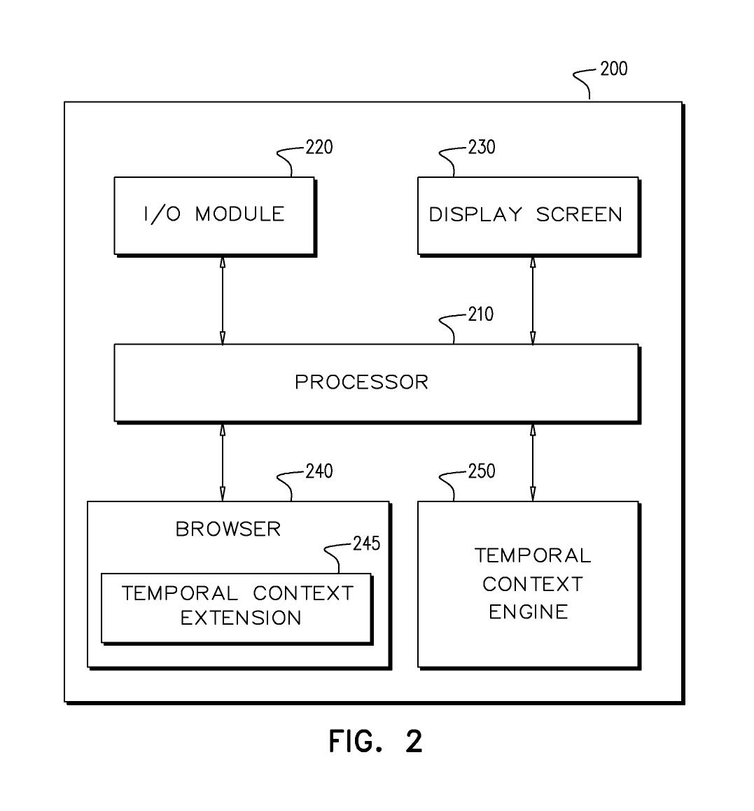

Reference is now made to FIG. 2 which represents a schematic illustration of an exemplary computing device 200 on which the webpage of FIG. 1 is presented.

Computing device 200 comprises hardware and software components, such as are well-known in the art. Computing device 200 also comprises at least one processor 210, I/O module 220 and display screen 230. It will be appreciated that computing device 200 may comprise more than one processor 210. For example, one such processor 210 may be a special purpose processor operative to present and process webpage 100 according to methods described herein. Processor 210 may be operative to execute instructions stored in a memory (not shown) in order to perform the herein described methods to present and process webpage 100. I/O module 220 may be any hardware or software component operative to use protocols such as are known in the art to communicate with a service provider such as that indicated by service provider indicator 160 (FIG. 1) to at least receive information used to populate temporal context choices 150 and associated scheduled broadcast times 151 and broadcast channels 152. Non-limiting examples of I/O module 220 may include a transceiver or a dedicated receiver. Display screen 230 may be implemented with any suitable display device. It will be appreciated that display screen 230 may be implemented either as a peripheral device or as an integral, built-in component of computing device 200.

Computing device may also comprise browser 240 and temporal context engine 250. Browser 240 may be implemented as any commercially available Internet browser, such as, for example, Microsoft Explorer, Google Chrome, or Mozilla Firefox. It will be appreciated that a browser 240 may also be implemented using a proprietary browser providing generally the same functionality. As will be described hereinbelow, temporal context engine 250 may be configured to generate the information for temporal context section 140 based on the other contents of webpage 100. It will be appreciated that the representation of temporal context engine 250 as an integral component of computing device 200 may be exemplary. Alternatively, temporal context engine 250 may be implemented as in the context of a server communicating with computing devices 200 via I/O module 220 to provide similar functionality.

It will be appreciated by one of ordinary skill in the art that real-time access to the contents of webpage 100 (FIG. 1) as it is presented on display screen 230 may be necessary in order for temporal context engine 250 to generate the information for temporal context section 140. Without such real-time access, it may not be possible to format temporal context section 140 in a timely manner. It will similarly be appreciated that the format used in the presentation of webpage 100 may affect the results of temporal context engine 250 when generating the information for temporal context section 140.

In accordance with embodiments described herein, browser 240 may comprise temporal context extension 245. Temporal context extension 245 is an application that extends the functionality of browser 240 to provide temporal context engine 250 real-time access to the contents and format of webpage 100. It will be appreciated by those of skill in the art that popular Internet browsers such as Microsoft Explorer, Google Chrome and Mozilla Firefox all support the installation of such extensions. Depending on user granted permissions, temporal context extension 245 may therefore be configured: to provide access to the URL of webpage 100 as it is presented in real time; to read the body of webpage 100 as it is presented; and to modify and re-render the body of the webpage 100 using overlays or in-page modification as it is presented.

It will be appreciated that the functionality of temporal context extension 245 may alternately be provided by configuring browser 240 to surf the Internet via a proxy server, where the proxy server is configured to provide real-time access and rendering services. Alternatively, or in addition, browser API's may be used to facilitate real-time access. Alternatively, the functionality of temporal context extension 245 may be built into a custom browser.

Real-time rendering and access may also be implemented by using notifications sent to, for example, a client installed application, such as a windows shell notification application. iPhone or Android notifications may be used for smartphone or computer tablet implementations of computing device 200. Notifications may also be used for wearable devices, such as, for example, Google Glass or smartwatches such as the Apple Watch, commercially available from Apple Inc.; the Galaxy Gear commercially available from Samsung Electronics Co.; and others.

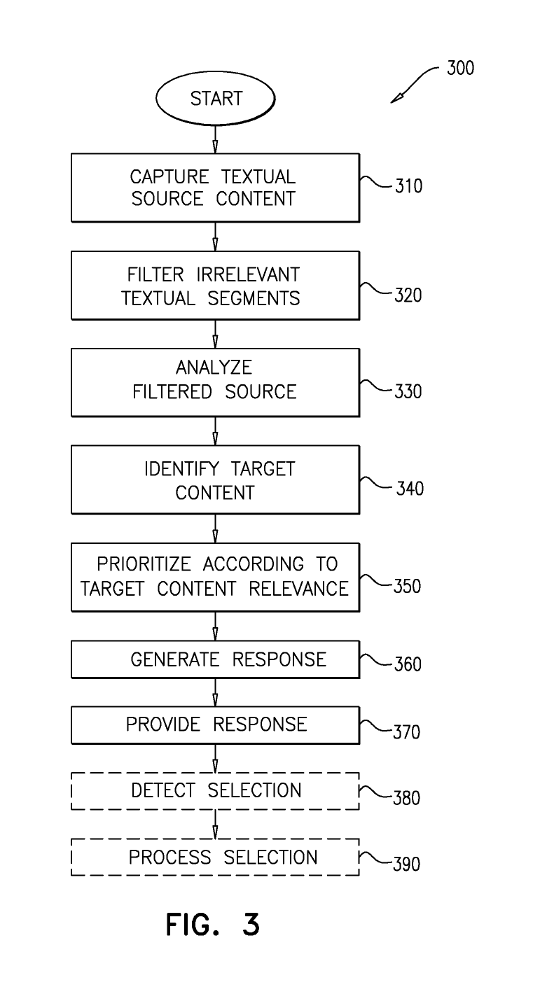

Reference is now made to FIG. 3 which is a flowchart of temporal context choice generation process 300, constructed and operative in accordance with embodiments described herein to be run by temporal context engine 250 on computing device 200 to provide the information for temporal context section 140 to be included in webpage 100.

Temporal context engine 250 captures (step 310) the textual source content viewed by the end user on webpage 100. Per the exemplary embodiment of FIG. 1, such textual source content may include, for example, title banner 110, page tabs 120 and prose 130. It will be appreciated by one of ordinary skill in the art that textual source content as described herein is associated with text provided by the provider of webpage 100 to render webpage 100. Accordingly, text in standard browser menu tabs, search bars, or as presented by add-in extensions is not captured in step 310. The captured textual source content may be provided directly from browser 240 via temporal context extension 245. Alternatively, or in addition, some, or all, of the textual source context may be obtained by directly downloading source text from a server hosting the URL currently being presented on webpage 100. Alternatively, or in addition, some or all of the textual source context may be obtained from a cache; the cache may be either a live cache or one built from crawling and indexing the web.

In addition to the textual source content, temporal context engine 250 may also obtain related resources such as semantic markup information, which may be used to determine the emphasis of certain sections of the source data. It will be appreciated that the specific technique or combination of techniques used for source capture may be dependent on domain-specific rules and conditions.

Temporal context engine 250 filters (step 320) the source files retrieved in step 310 to remove segments that may be irrelevant to the data analysis to be performed. This may include removal of headers/footers/sidebars as well as also detection of other segments deemed irrelevant. For example, temporal context engine 250 may inspect the markup for appropriate HTML, tags (e.g. <header>, <footer>), and compare it with other pages on the same site to extract unique content from the page. Per the exemplary embodiment of FIG. 1, temporal context engine 250 may also filter some or all of page tabs 120 per a list of common or generically used page tabs. For example, page tabs 120 such as “Search”, “Useful Links”, “Photo Gallery”, “News”, “Facebook”, “Twitter”, “LinkedIn” and “YouTube” may be included in a list of generic, commonly used headers and tabs that may provide little or no contextual information with regard to the content of webpage 100. Accordingly, these page tabs 120 may be filtered out in step 320.

Temporal context engine 250 may also strip mark-up, such as marks for bullet lists and paragraphs. Alternatively, temporal context engine 250 may be configured to retain some or all mark-up in order to provide emphasis or lexical structural information for downstream analysis. Temporal context engine 250 may be configured to normalize the original mark-up information and perform analysis of cascading style sheets (CSS) to add emphasis or visibility and/or other structural information to the output of step 320 for downstream analysis. It will be appreciated that the specific technique or combination of techniques used to perform the filtering in step 320 may be dependent on domain-specific rules and conditions.

Temporal context engine 250 analyzes (step 330) the filtered source using one or more of a range of language techniques, including, for example, noun-phrase detection, keyword detection, thematic extraction, sentiment analysis, and corpus linguistic analysis. This analysis may output a range of textual outputs that may be suitable for identification of appropriate target content, for example: sets of n-grams, ordered lists of keywords, themes and sentiments. It will be appreciated that the specific technique or combination of techniques used to perform the analysis in step 330 may be dependent on domain-specific rules and conditions.

Temporal context engine 250 identifies (step 340) matches between the source analysis results and a target content set. The target content system may be any suitable collection of available content. For example, per the exemplary embodiment of FIG. 1, the target content may be a range of currently scheduled television programs provided by the service provider indicated by service provider indicator 160. The target content may also be a catalogue of products available for purchase, a library of news content, and so on. Furthermore, multiple target content sets may be used to provide end users with results from multiple domains. The target content set may also be selected by taking into account other contextual information, such as the user's location, television platform, time of day, news outlet preferences, etc.

Output from the analysis stage may be compared with various attributes of the target content, for example: title, genre, actors, and/or keywords. It may also be compared against derived information from the target content, such as thematic analysis of the synopsis or description of the content. In accordance with embodiments described herein, a multiplicity of matching algorithms may be defined for use in step 340. The matching algorithms may be differentiated by the assignment of weights to component matching factors such as user behavior, environment, the content of webpage 100 and the target content set. Examples of user behavior may include click through rates and actions performed (e.g., viewing or recording associated content). Examples of environment may include geographical location, time of day, day of week, season and special events such as the Olympics or the World Cup. Over time, user behavior may be tracked to determine which of the matching algorithms is more successful at generating user interest. In accordance with embodiments described herein, the use of more successful matching algorithms may be prioritized over time. It will be appreciated that the specific technique or combination of techniques used to perform the identification in step 340 may be dependent on domain-specific rules and conditions.

Temporal context engine 250 prioritizes (step 350) the identified content in accordance to target content relevance for the end user per the current contents of webpage 100. For example, per the exemplary embodiment of FIG. 1, temporal context choices 150 may be ordered in accordance with a broadcast schedule per scheduled broadcast times 151. Alternatively, or in addition, multiple content items in the same group (e.g. episodes of the same TV show) may be collapsed into a single entry. Alternatively, or in addition, popular content items, e.g., television programs with high ratings, may be boosted. Alternatively, or in addition, the order may be adjusted in accordance with other factors. For example, the provider of webpage 100 may adjust the ordering in return for monetary and/or other considerations. Alternatively, or in addition, temporal context engine 250 may introduce randomization to create serendipity. Prioritization may also take into account information from step 340 such as match scores or emphasis information evident in the source. It will be appreciated that the specific technique or combination of techniques used to perform the prioritization in step 350 may be dependent on domain-specific rules and conditions.

Temporal context engine 250 generates (step 360) a response containing any additional contextual information that may be relevant to the end user, such as television tune-in information, price, graphics and descriptive text. The response generation may also take into account any requested paging information received from the client to allow the end user to scroll through results.

The generated response may be provided (step 370) to browser 240 either in a pure data format (e.g., JSON, XML, etc.) or as rendered output (e.g., HTML, Image, WebGL, etc.). Alternatively, or in addition, the generated response may be provided to another webpage and/or via the operating system notification system. Browser 240 may then present the response as part of webpage 100, for example, as temporal context section 140 as depicted in FIG. 1.

It will be appreciated that the representation of temporal context section 140 is exemplary; other representations may also be included in the context of the herein described methods. For example, the information included in temporal context section 140 may alternatively be presented in other locations on webpage 100 (e.g., on the top of the page) or as “marked up” text within the body of the page. The display of temporal context section 140 may also be initially hidden, and available for presentation based on a user-option. Alternatively, or in addition, temporal context section 140, or at least a variation thereof, may be rendered for presentation on a second device. For example, computing device 200 (on which webpage 100 is presented) on a desktop computer; temporal context section 140 may be rendered for presentation and further processing on a second device such as a television, tablet computer or smartphone connected to computing device 200 via the Internet, a home network, or other suitable means.

It will be appreciated that process 300 may be extended to provide further processing after browser 240 presents the generated response. For example, temporal context choices 150 may be presented by browser 240 as “clickable” links to open the associated content per an associated URL. Scheduled broadcast times 151 and broadcast channels 152 may also be presented as clickable links that may, for example, be operable to open associated content such as electronic program guides associated with a given scheduled broadcast time 151 or broadcast channel 152.

In accordance with embodiments of the present invention, computing device 200 may comprise a media player for playing video content and/or a storage device suitable for recording video content. Browser 240 may detect (step 380) selection of a clickable link and process (step 390) the selection by opening up, recording or downloading/saving the associated content on computing device 200 and/or a second device, such as, for example, a television or STB. In accordance with embodiments of the present invention display screen 230 may be implemented as a touchscreen; the user selection may therefore be entered via display screen 230. Alternatively, or in addition, the selection may be input via any other suitable user interface (UI) device, such as, for example, a mouse, a pointing device, a voice command receiver or a keyboard.

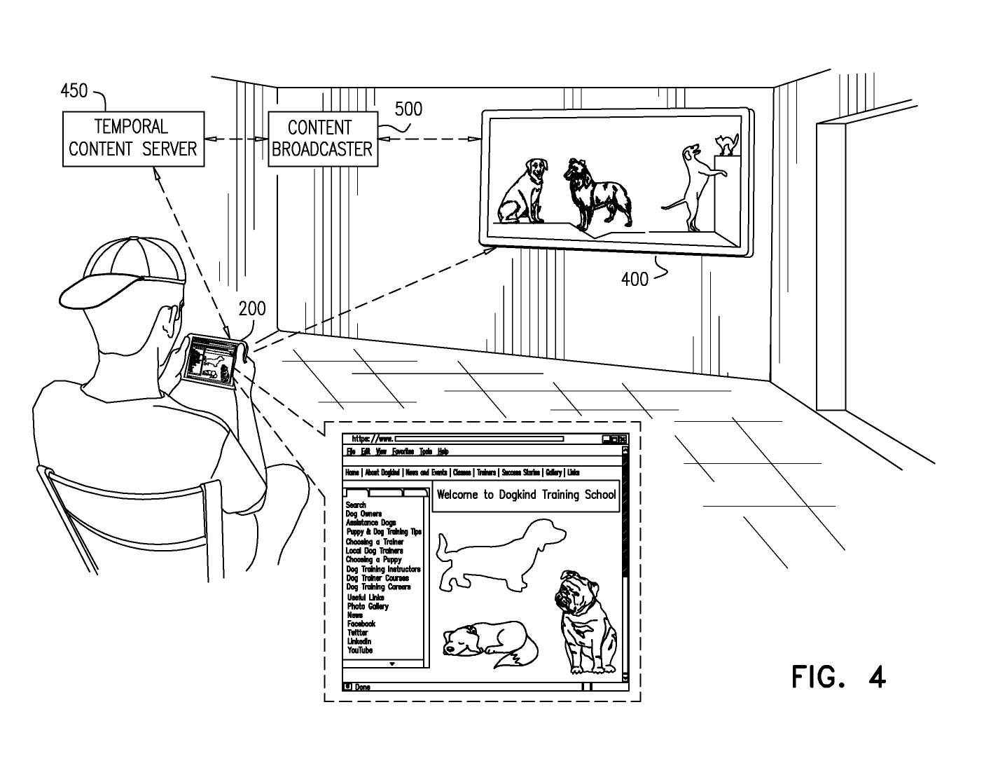

Reference is now made to FIG. 4 is a simplified pictorial illustration of computing device 200 in communication with a second device 400, constructed and operative in accordance with embodiments of the present disclosure. It will be appreciated that step 390 may alternatively, or in addition, include sending notification of a selection in step 380 to second device 400. Second device 400 may be, for example, a television, an STB and/or a digital video recorder (DVR). I/O module 220 (FIG. 2) may be employed by browser 240 to send a selection notification message to second device 400. The selection notification message may include one or more instructions to second device 400. For example, the selection notification message may instruct second device 400 to change to a specific broadcast channel 152, to schedule a recording of a broadcast channel 152 in accordance with a scheduled broadcast time 151, and/or, to open an EPG page with the suggested content. Second device 400 may receive the content associated with the selection notification message from content broadcaster 500.

It will be appreciated that the depiction of temporal context engine 250 as a component of device 200 in FIG. 2 may be exemplary. Temporal context engine 250 may also be implemented in the context of an external server in communication with computing device 200. The functionality of temporal context engine 250 may also be distributed such that one or more elements are implemented as a component of computing device 200 and one or more elements are implemented in an external server. In accordance with some embodiments disclosed herein, some or all of the functionality of temporal content engine 250 may be provided by a temporal content server 450. For example, temporal content server 450 may also communicate with content broadcaster 500 to access the target content set while performing step 340.

In accordance with embodiments described herein, a range of caches may be employed to reduce the overhead of multiple calculation steps for the same source content. Furthermore, depending on the amount of personalization and time/location dependence in the selected content/processing rules, it may be feasible to provide a previously generated response directly from cache.

It will be appreciated by one of ordinary skill in the art that the methods described herein may not be limited only to implementation in the context of temporal availability of television programming. For example, process 300 may also be configured to provide currently available products and prices based on the contents of a webpage such as webpage 100. Process 300 may be configured to analyze the body of a webpage in a generally similar manner to find products and prices. Temporal context engine 250 may be configured to find more competitive deals, which may be presented in temporal context section 140.

Process 300 may also be configured to provide currently available background Information. Temporal context engine 250 may be configured to surface key nouns, events, themes, etc. Step 340 may be configured to find links to background information articles in a corpus such as Wikipedia.

It will be appreciated by one of ordinary skill in the art that per the description of process 300, the information presented by browser 240 in temporal context section 140 is determined as a function of temporally available content that is in some way thematically related to the current contents of webpage 100. It will similarly be appreciated that this functionality may be provided independent of the identity, history, and/or previously defined preferences of the user.

In according with embodiments described herein, this functionality may be extended by a number of personalization options. For example, users of computing device 200 may choose to identify themselves and their preferences. In this mode, the user may input preferences for the set or type of content to be presented in temporal context section 140. For example, a user may enter preferences such as: “never this show”, “prefer content on this channel/from this broadcaster” etc. These preferences may be used by temporal context engine 250 in step 350 to change the set of content or the relative priority of content presented in temporal context section 140.

Alternatively, or in addition, a user may choose to link an additional identity to the system. Such an identity may include additional information about the user; for example a social network identity may include preferences for content, the user's location, demographic information, etc. which may also be used to change the set of content or the relative priority of content presented in temporal context section 140. Such an identity may also trigger downstream actions on the associated content. For example a television identity may trigger “play now” or “record for later” actions by computing device 200 and/or second device 400. A social network identity may similarly trigger actions to “share” or “like” the associated content within the network.

Alternatively, or in addition, temporal context extension 245 and/or temporal context engine 250 may be configured to track the history of the websites viewed by the user, and/or some derived “themes” or “keywords” of the sites, and store this information over time. This information could also be used by the various steps of process 300 to personalize its output for a particular viewer or set of viewers.

It will be appreciated that the embodiments described hereinabove focus primarily on the analysis of textual source on webpage 100. Alternatively, or in addition, other media, such as, for example, images, videos and audio clips may be used in an analogous manner to produce temporal context choices 150. By way of example, an image search engine such as Google Images may be used to return a name or description of an image; an audio recognition service such as provided by Shazam Entertainment Ltd. may be used to return a name and/or lyrics for an audio clip. The resulting text (i.e., the returned name, description or lyrics) may be processed by process 300 in generally the same manner as textual source directly harvested from webpage 100.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A method implemented on a computing device, the method comprising:
analyzing textual source content from a currently presented webpage on said computing device;
based on said analyzing, determining at least one content theme contextually related to said webpage;
receiving details of at least one currently scheduled television program on said computing device, wherein said at least one currently scheduled television program is matched to said at least one content theme; and
rendering said currently presented webpage to include at least an indication of said currently scheduled television program in accordance with said details.

2. The method according to claim 1 and wherein said indication is linked to a uniform resource locator (URL) for said currently scheduled television program.

3. The method according to claim 1 and also comprising:
detecting selection of said currently scheduled television program; and
processing said selection of said currently scheduled television program, wherein said processing comprises at least one of: presenting or recording said currently scheduled television program.

4. The method according to claim 3 and also comprising scheduling said processing to be performed in accordance with said details of at least one currently scheduled television program.

5. The method according to claim 3 and also comprising:
sending notification of said selection to a second device, wherein said notification instructs said second device to perform said at least one of: presenting or recording said currently scheduled television program.

6. The method according to claim 1 and also comprising:
sending said details to a second device for presentation on said second device.

7. The method according to claim 1 and wherein said at least one currently scheduled television program is available from a television broadcaster and said details comprise at least one of: a television program name, a scheduled broadcast time associated with said television program name, or a broadcast channel associated with said television program name.

8. The method according to claim 1 and wherein said at least one currently scheduled television program is available from an over-the-top (OTT) service.

9. The method according to claim 1 and wherein said analyzing comprises:
capturing text from content on said currently presented webpage; and
filtering out irrelevant text segments from said captured text.

10. The method according to claim 1 and wherein said textual source content is not presented in a search bar.

11. The method according to claim 1 and wherein said rendering comprises:
ordering said details according to at least a broadcast schedule for said at least one currently scheduled television program.

12. The method according to claim 1 and wherein said receiving details comprises:
receiving a schedule of currently scheduled television programs on said computing device which includes said at least one currently scheduled television program;
matching said at least one content theme to said at least one currently scheduled television program; and
deriving at least one matching score as an estimation of success for said matching.

13. The method according to claim 1 and further comprising prior to said receiving, forwarding said at least one content theme to a temporal context server, wherein said details of at least one currently scheduled television program are received from said temporal context server.

14. The method according to claim 1 and wherein said receiving details comprises:
forwarding said at least one content theme to a temporal context server; and
receiving from said temporal context server at least one matching score indicating an estimation of success for matching said at least one currently scheduled television program to said at least one content theme.

15. The method according to claim 12 and wherein:
said rendering comprises ordering said details according to said at least one matching score.

16. The method according to claim 1 and wherein at least some of said textual source content is derived from at least one of an image, a video or an audio clip on said currently presented webpage.

17. A computing device comprising:
a processor;
a display screen;
a browser to be executed by said processor and operative to present a webpage on said display screen; and
a temporal context engine to be executed by said processor and operative to:
analyze textual source content from said webpage while currently presented on said display screen,
determine at least one content theme contextually related to said analyzed textual source content,
receive details of said at least one currently scheduled television program to said computing device, wherein said at least one currently scheduled television program is matched to said at least one content theme, and
render said currently presented webpage to include at least an indication of said currently scheduled television program in accordance with said details.

18. The computing device according to claim 17 and also comprising:
a user interface (UI) device operative to enable a user to select said at least an indication of said currently scheduled television program.

19. The computing device according to claim 18 and also comprising:
an I/O module configured to receive said currently available content item; and at least one of:
a media player configured to play said currently scheduled television program, or
a storage device to record said currently scheduled television program.

20. A computing device comprising:
means for analyzing textual source content from a currently presented webpage on said computing device;
means for determining at least one content theme contextually related to said webpage based on said analyzing;
means for receiving details of said at least one currently scheduled television program on said computing device, wherein said at least one currently scheduled television program is matched to said at least one content theme; and
means for rendering said currently presented webpage to include at least an indication of said currently scheduled television program in accordance with said details.
